(19) United States
(12) Patent Application Publication
(10) Pub. No.: US 2026/0202693 A1
(43) Pub. Date: Jul. 16, 2026

(54) OPTICAL POWER LIMITER

(71) Applicant: NATIONAL UNIVERSITY OF SINGAPORE, Singapore (SG)

(72) Inventors: Chao WANG, Singapore (SG); Jianran ZHANG, Singapore (SG); Gong ZHANG, Singapore (SG); Ci Wen LIM, Singapore (SG)

(73) Assignee: NATIONAL UNIVERSITY OF SINGAPORE, Singapore (SG)

(21) Appl. No.: 19/135,624

(22) PCT Filed: Dec. 5, 2023
(86) PCT No.: PCT/SG2023/050809

§ 371 Date: Jun. 4, 2025

(30) Foreign Application Priority Data
Dec. 5, 2022 (SG) 10202260320Y

(51) Int. Cl. G02F 1/01; G02B 6/26; G02B 6/32

(52) U.S. Cl. CPC G02F 1/0147; G02B 6/264; G02B 6/32; G02F 2203/52

(57) ABSTRACT

An optical power limiter, a method of fabricating an optical power limiter, an optical device or system comprising an optical power limiter, and a method of limiting optical power using on optical power limiter. The optical power limiter comprises a first optical mode altering element configured to receive an input optical signal from a first waveguide; and an active medium coupled to the first optical mode altering element at a first end of the active medium such that a mode altered optical signal based on the input optical signal can enter the active medium, wherein a second end of the active medium is configured to couple the mode altered optical signal into a second waveguide as an optical output signal; wherein the active medium has a thermo-optic coefficient such that the mode altered optical signal entering the active medium experiences a refractive index gradient in the active medium as a result of absorption; and wherein the power of the optical output signal coupled into the second waveguide is limited to a maximum power value based on mode overlap of the mode altered optical signal and the second waveguide.

### FIELD OF INVENTION

The present invention relates broadly to an optical power limiter, in particular to a miniaturised optical power limiter for quantum and classical optical communication with improved performance.

### BACKGROUND

Any mention and/or discussion of prior art throughout the specification should not be considered, in any way, as an admission that this prior art is well known or forms part of common general knowledge in the field.

A number of optical power limiter designs have been reported.
(1) PCT/SG2021/050403: An optical power limiter design using free space optics to launch light into an active medium, in which the power limiting is based on the thermo-optical defocusing effect in the active medium. When the input light beam has a relatively high optical power, the absorption-induced reflective index gradient in the active medium works as a concave lens and defocuses the light beam. In this way, the device can dynamically control the amount of optical power transmitted through a diaphragm. As a result, the final output optical power is limited even with the increase of the input optical power. This design is bulky and weighty, and has a relatively large insertion loss.
(2) Fiber-optical power limiter based on liquid core optical fiber (IEEE Photonics Technology Letters 24, 297-299, (2011)): The power limiting effect in a liquid-core optical fiber (LCOF) has been proposed, where the absorption of evanescent field in the thin absorption layer deposited on the LCOF cladding will cause heat accumulation, which increases the temperature of the fiber. Since the thermal-optical coefficients of the core and cladding experience differential heating, this decreases the transmission efficiency of the light propagating in the fiber core and limits the final output power. Liquid-core optical fibers are not commercially available and will incur a large manufacturing cost.
(3) Fiber-optical power limiter based on optical adhesive (Applied Optics 40, 6611 (2001)): In this paper, the output power limiting is achieved by utilizing the thermal-optical effect of the optical adhesive connecting the two fiber collimators. Connection of two fiber collimators with optical adhesive is a technically demanding endeavor, which involves consistent UV curing of the adhesive at every point, precise calibration of the collimators caused by adhesive shrinkage, etc.
(4) Optical power limiter based on photonic chip micro-ring resonator (Scientific Reports 4, 6676, (2014)): Chip-based micro-ring resonator has a specific working frequency. When the absorption of the input light increases the temperature of the ring resonator, its working wavelength will shift and therefore attenuates the input light. Therefore, the power limiting effect applies only on a specific working wavelength of the input signal and has limited power limitation on the output power.

Embodiments of the present invention seek to address at least one of the above problems.

### SUMMARY

In accordance with a first aspect of the present invention, there is provided an optical power limiter comprising:
a first optical mode altering element configured to receive an input optical signal from a first waveguide; and
an active medium coupled to the first optical mode altering element at a first end of the active medium such that a mode altered optical signal based on the input optical signal can enter the active medium, wherein a second end of the active medium is configured to couple the mode altered optical signal into a second waveguide as an optical output signal;
wherein the active medium has a thermo-optic coefficient such that the mode altered optical signal entering the active medium experiences a refractive index gradient in the active medium as a result of absorption; and
wherein the power of the optical output signal coupled into the second waveguide is limited to a maximum power value based on mode overlap of the mode altered optical signal and the second waveguide.

In accordance with a second aspect of the present invention, there is provided a method of fabricating an optical power limiter comprising:
configuring a first optical mode altering element to receive an input optical signal from a first waveguide;
coupling an active medium to the first optical mode altering element at a first end of the active medium such that a mode altered optical signal based on the input optical signal can enter the active medium; and
configuring a second end of the active medium to couple the mode altered optical signal into a second waveguide as an optical output signal;
wherein the active medium has a thermo-optic coefficient such that the mode altered optical signal entering the active medium experiences a refractive index gradient in the active medium as a result of absorption; and
wherein a power of the optical output signal coupled into the second waveguide is limited to a maximum power value based on mode overlap of the mode altered optical signal and the second waveguide.

In accordance with a third aspect of the present invention, there is provided an optical device or system comprising the power limiter in of the first aspect.

In accordance with a fourth aspect of the present invention, there is provided a method of limiting optical power using the power limiter of the first aspect.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing of an optical power limiter according to an example embodiment.

FIG. 2 shows a schematic drawing of an optical power limiter according to an example embodiment.

FIG. 3 shows a schematic drawing of an optical power limiter according to an example embodiment.

FIG. 4A shows experimental results of the optical power limiter of FIG. 2, where single mode fibers are used as the input and output waveguide, and GRIN lens as the input optical structure. The beam width is changing while the medium length remains fixed at 100 μm.

FIG. 4B shows experimental results of the optical power limiter of FIG. 2, where single mode fibers are used as the input and output waveguide, and GRIN lens as the input optical structure. The beam width is changing while the medium length remains fixed at 200 μm.

FIG. 4C shows experimental results of the optical power limiter of FIG. 2, where single mode fibers are used as the input and output waveguide, and GRIN lens as the input optical structure. The beam width is changing while the medium length remains fixed at 300 μm.

FIG. 5 shows experimental results of optical power limiter of FIG. 3, where single mode fibers are used as the input and output waveguides, and GRIN lenses as the input and output optical structure.

FIG. 6 shows a schematic drawing of a power limiter array for multi-channel applications according to an example embodiment.

FIG. 7 shows the responsivity result measured at 1 mW CW input optical power under 2 V bias voltage after 5s illumination of 1 MHz pulses with the protection of PL, according to an example embodiment.

FIG. 8 shows responsivity result measured at 1 mW CW input optical power under 2 V bias voltage after 5s illumination of 10 MHz pulses with the protection of PL, according to an example embodiment.

FIG. 9 shows responsivity result measured at 1 mW CW input optical power under 2 V bias voltage after 5s illumination of 100 MHz pulses with the protection of PL, according to an example embodiment.

FIG. 10 shows responsivity change measured at 1 mW CW input optical power under 2 V bias voltage after up to 5s illumination of 1 MHz pulses at 14.7 W peak power without the protection of PL, according to an example embodiment.

FIG. 11 shows a schematic drawing of the setup for faithfully monitoring the input optical power and perform feedback control in quantum cryptography to achieve 1) ultra-low power limiting threshold. 2) instantaneous optical power limiting, according to an example embodiment.

FIG. 12 shows a flowchart illustrating a method of fabricating an optical power limiter, according to an example embodiment.

### DETAILED DESCRIPTION

Embodiments of the present invention provide an optical power limiter. Embodiments of the present invention can have several advantages, including, but not limited to, one or more of:
1. Miniature size: the optical power limiter according to an example embodiment is able to achieve optical power limiting with a beam size of micro-meter, which is suitable for waveguide implementation, for example optical fiber and photonic integrated chips.
2. Minimal insertion loss: the optical power limiter according to an example embodiment optimises the optical mode coupling in the low input power case. So the insertion loss in low input power scenarios are minimal.
3. Adjustable power limiting threshold (i.e. maximum output optical power): the optical power limiter according to an example embodiment provides configurable system parameters to adjust the power limiting threshold.
4. Minimal distortion on the signal: The optical power limiter according to an example embodiment adds only attenuation on the input optical signal, and introduces minimal impact (if not negligible impact) on the intensity, phase, or polarization degrees of freedom of the input optical signal.

Industrial applications of embodiments of the present invention include, for example, to the following:
1. Optical communication
2. Sensing
3. Quantum cryptography

Optical power limiters according to example embodiments focus on waveguide input and output, and handle the input beam with a much smaller beam size compared to existing proposals such as PCT/SG2021/050403. This advantageously gives a greater power density in the active medium, leading to a stronger thermo-optical defocusing effect, which results in a shorter transmission distance and a smaller absorption loss. Moreover, different from the proposal in PCT/SG2021/050403 where free-space optical transmission is considered, embodiments of the present invention are based on the mode overlap condition as a replacement of diaphragm. By managing the mode overlap conditions for the input and output light, one can advantageously optimise the power limiting threshold and the insertion loss relations of the optical power limiter according to example embodiments for the best performance.

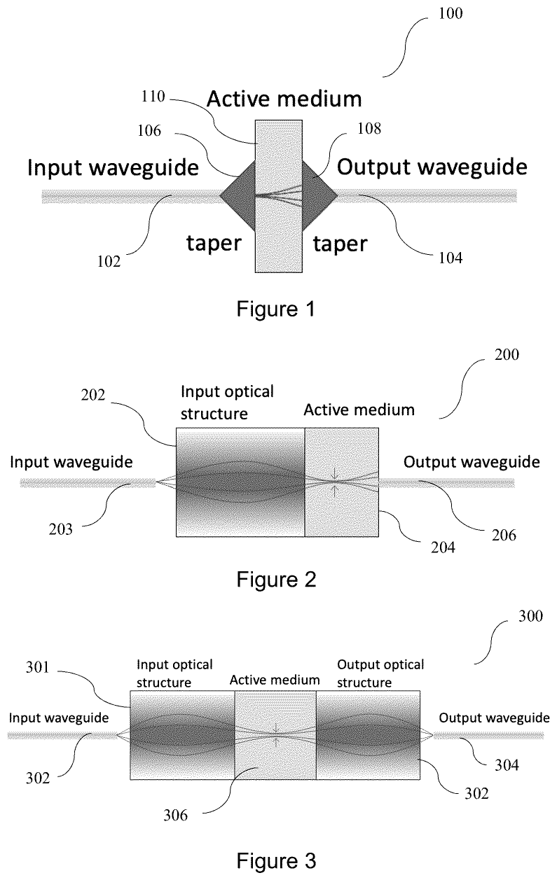

A first optical power limiter 100 according to an example embodiment is shown in FIG. 1, which comprises the input and output waveguide 102, 104, taper 106, 108 and the active medium 110. The waveguide 102, 104 can be optical fiber, waveguide in photonic integrated circuit (PIC), etc in various example embodiments. The taper 106, 108 is an optical structure which can alter the optical mode of the input and output light from the waveguides 102, 104. Example of the taper 106, 108 can be the core expansion in the optical fiber, taper structure, and large core waveguide mode converter in PIC platforms, in various example embodiments. In the optical power limiter 100, one can alter the beam parameters in the active medium 110 and manage the optical mode overlap of the output waveguide 104. The active medium 110 is where the thermo-optical defocusing effect takes place.

A second optical power limiter 200 according to an example embodiment is shown in FIG. 2. The taper is replaced with an optical structure 202 for coupling to the input waveguide 203, which can alter the optical mode and the beam parameters. The optical structure 202 can be micro lenses, Gradient-Index (GRIN) Lenses, collimators, and the waveguide version of all the previous mention structures, etc, in various example embodiments. The function of this optical structure 202 can be light focusing inside the active medium 204, which gives a modifiable beam waist and focal length. In this way, adjustable system parameters (power limiting threshold, insertion loss) can be achieved in the coupling to the output waveguide 206.

A third optical power limiter 300 according to an example embodiment is shown in FIG. 3. A first optical structure 301 for coupling to the input waveguide 302 is provided, which can alter the optical mode and the beam parameters. A second optical structure 303 is placed at the output side for coupling to the output waveguide 304, to optimize the mode overlap between the optical mode after the active medium 306 and the output waveguide 304. In this way, the mode mismatch (and the insertion loss) is minimal for the low input power case. While in the high input power case, the light beam in the active medium 306 will diverge because of the thermo-optical defocusing effect, leading to a significant mode mismatch in the light coupling to the output waveguide 304, which limits the output optical power.

Furthermore, the length of the active medium 306 can be adjusted to obtain different power limiting thresholds. In this way, adjustable power limiting threshold with minimal insertion loss can be achieved.

Non-limiting example embodiments according to FIGS. 2 and 3 are using single mode fiber (SMF28, mode field diameter: 10.4 μm @ 1550 nm) as the input and output waveguide, GRIN lenses as the input and output optical structure, and optical adhesive with negative TOC as the active medium.

Based on this configuration, experiments were conducted for the optical power limiter 200 (FIG. 2) and the optical power limiter 300 (FIG. 3). The single mode fiber is a commonly used waveguide for optical communication and quantum cryptography, which could be easily integrated in the fiber optical systems. The GRIN lens has a compact size of only ~mm in diameter and length, and the optical adhesive is also widely used in optical systems. Both GRIN lenses and optical adhesive are cost-effective and easily accessible.

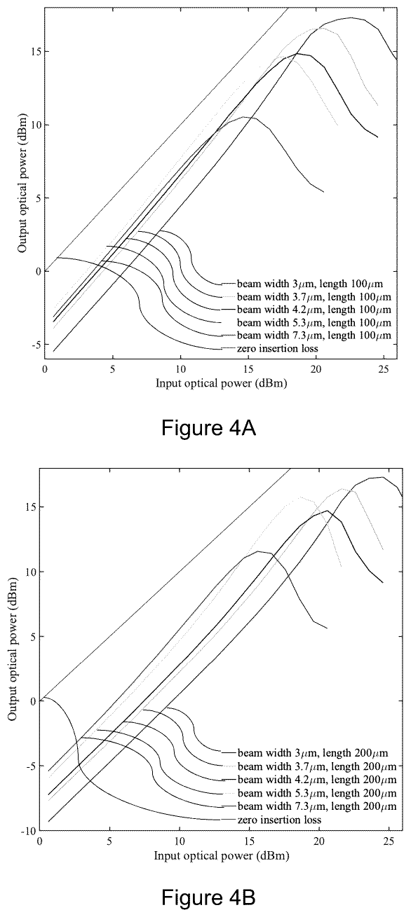

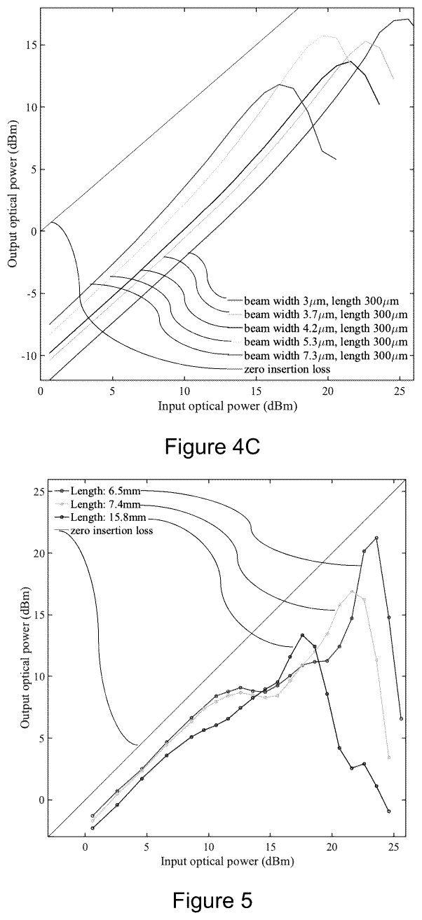

The experimental results of the optical power limiter 200 are shown in FIGS. 4A-C. By configuring the beam width (3 μm to 7.3 μm) and the medium length (100 μm to 300 μm), adjustable power limiting threshold (10.53 dBm (11.3 mW)-17.3 dBm (53.7 mW)) and insertion loss (3.1 dB-12.6 dB) are achieved.

The experimental results of the optical power limiter 300 are shown in FIG. 5. By changing the medium 306 length (distance between two GRIN lenses, from 6.5 mm to 15.8 mm), the power limiting threshold is adjustable from 13.36 dBm (21.7 mW) to 21.25 dBm (133.4 mW), with an insertion loss changing from 1.89 dB to 2.9 dB for the low input power case. The insertion loss could be further reduced by improving the mode-matching and the interface reflections, in different example embodiments.

As described above, it was demonstrated that embodiments of the present invention can achieve a miniaturized power limiting effect with a much smaller footprint (~mm) compared to existing proposal such as PCT/SG2021/050403 (~10 cm), minimal insertion loss (~1.89 dB) compared to existing proposal such as PCT/SG2021/050403 (~5.1 dB), and an adjustable power limiting threshold.

The optical power limiters according to example embodiments can be useful in various industrial applications, for example in quantum cryptography and optical communication:

In quantum cryptography, the optical power limiter according to an example embodiment can be used as a countermeasure against trojan-horse attack by limiting the energy of the eavesdropping light, potential countermeasure against plug-and-play QKD with untrusted light sources, and potential counter measure against bright illumination attacks including laser damage attacks and detector blinding attacks [PRX QUANTUM 2, 030304 (2021)].

With features of low insertion loss and a small footprint, embodiments of the present invention can work as a general component for protecting quantum cryptography systems. For example, the small insertion loss and the compact size enable a higher level of system integration, especially for the receiver side.

In the most widely deployed BB84 Quantum Key Distribution (QKD) system, it has been shown that the receiver is one of the most vulnerable parts of the whole system, where the detectors could be manipulated by a strong eavesdropping light [Nat Photon 4, 686 (2010), Rev. Mod. Phys. 92, 025002 (2020)]. A standard countermeasure to such an attack is to actively monitor the input light power. However, it has been shown that the monitoring devices could also be hacked by laser-damage attack. In this case, the calibrated system parameters can be changed, and the monitoring device can be damaged. How to tackle this problem is an open problem to the field [Phys. Rev. A 94, 030302 (2016), Phys. Rev. A 91, 032326 (2015)]. In previous literatures, it has been shown that changing the device parameters needs an eavesdropping optical power of >0.25 W. For instance, a Si single photon detector under >0.25 W CW light observed temporal parameter change like efficiency, dark count rate, breakdown voltage, etc. [Phys. Rev. Lett. 112, 070503 (2014)]. The InGaAs PIN detector for monitoring shows changes in photosensitivity with >0.5 W CW light input [Phys. Rev. A 94, 030302 (2016)]. Moreover, attenuators, circulators and isolators also show parameter change with >1 W CW light input [Phys. Rev. Applied 13, 034017 (2020), arXiv:2201.06114]. Advantageously, the optical power limiter according to example embodiments regulates the energy of the output light, no matter how strong the input light is. As such, the optical power limiter according to example embodiments can provide an excellent protection for the calibrated components and devices. Advantageously, the small insertion loss introduces minimal degradation to the signal-to-noise ratio for the system, making the optical power limiter according to example embodiments suitable as a general component for both the transmitter and receiver protection.

In optical communications, regulating the optical power is also very important. The optical power limiter according to example embodiments can be useful in power equalization in wavelength division multiplexing (WDM) systems, erbium-doped fiber amplifiers (EDFA) gain control, receiver protection, etc.

In a WDM system, multiple wavelength channels arriving at a node may be transmitted through different optical passes and have different output power. Before the combined signals enter the optical amplifier, it is required that the optical power of these channels is equalized to maintain appropriate optical amplifier performance. This is typically done by actively monitoring and controlling the optical power [“MEMS variable optical attenuator (VOA) for DWDM applications.” Design, Test, Integration, and Packaging of MEMS/MOEMS 2002. Vol. 4755. SPIE, 2002. “Micromachined electromagnetic variable optical attenuator for optical power equalization.” Journal of Micro/Nanolithography, MEMS, and MOEMS 4.4 (2005): 041304.]. The optical power limiter according to example embodiments can provide automatic power control, with minimum insertion loss to the input signal. The optical power limiter according to example embodiments has great potential to complement or even replace the techniques in the power equalization in WDM systems.

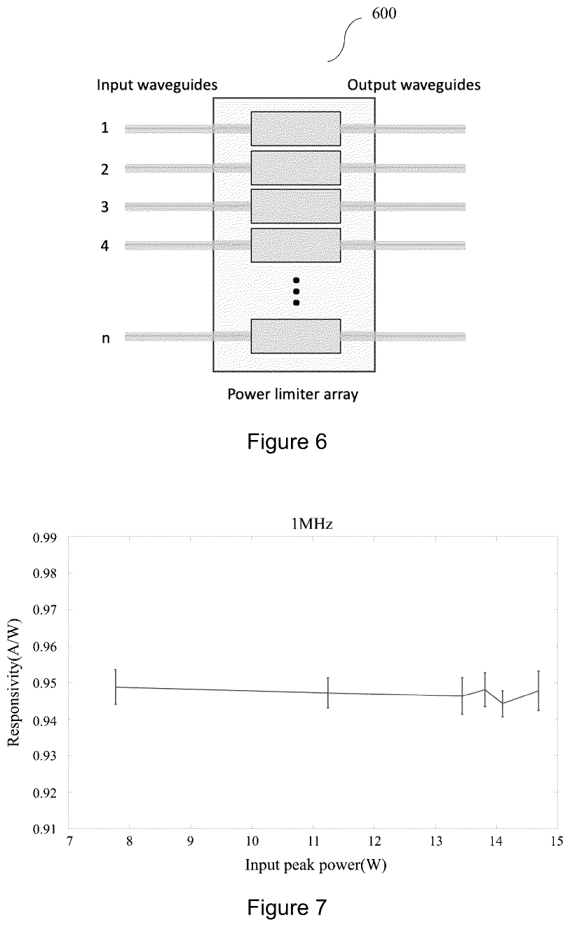

FIG. 6 shows a schematic drawing of a power limiter array 600 for multi-channel applications according to an example embodiment.

Another issue in WDM networks is the wavelength-dependent gain saturation of the EDFA. When the input optical power becomes a significant fraction of the pump power, it will cause pump depletion and the reduction in amplifier gain. Because of this effect, the loss or removal of one or more channels at the input of an EDFA can cause large changes in the output power of the remaining channels [“Comparison of gain control techniques to stabilize EDFAs for WDM networks.” Optical Fiber Communications, OFC . . . IEEE, 1996., WIPO (PCT) WO2003014775A2]. With the optical power limiter according to example embodiments, one can limit the input power of all channels below the threshold, avoiding the EDFA gain saturation.

Also, the optical power limiter according to example embodiments is useful for receiver protection. As described earlier, if the channel happens to have high power optical input, the receiver performance could be altered, or the receiver could even be damaged. The optical power limiter according to example embodiments provides an automatic power regulation preventing such damage, with minimum losses on the optical signal in normal operating conditions.

The feasibility of using the optical power limiter according to example embodiments for optical device protection was experimentally verified. The experimental scheme is based on a pair of single-mode optical fibers and GRIN lenses in the optical power limiter 300 shown in FIG. 3. Experiments were conducted with four experimental configurations, as shown in the below table I, to test whether the optical power limiter according to an example embodiment can protect a photodetector from being attacked by externally injected strong lasers.

TABLE I

| | | | Pulsed | |
|---|---|---|---|---|
| | CW laser | CW laser | laser | pulsed laser |
| | input | input | input | input |
| With power limiter | Yes | No | Yes | No |
| in place | | | | |
| Photodiode get | No | Yes | No | Yes |
| damaged | | | | |

Specifically, the laser attack experiment was conducted based on continuous-wave (CW) laser input and pulsed laser input. For the CW laser input, the optical power of the laser was gradually increased, sent through the optical power limiter according to an example embodiment, and injected into a fiber-coupled InGaAs photodiode. The attack was performed with different input optical power up to 1 W, and the responsivity (or quantum efficiency) of the photodiode under test remains unchanged.

The experiments were also conducted with the optical power limiter removed from the setup. By increasing the input CW optical power, and illuminate the light on the photodiode for 5s, it was observed that the responsivity of the photodiode starts decreasing when the input optical power goes above 300 mW. These changes to the photodiode are permanent and will modify the calibrated parameter of the system.

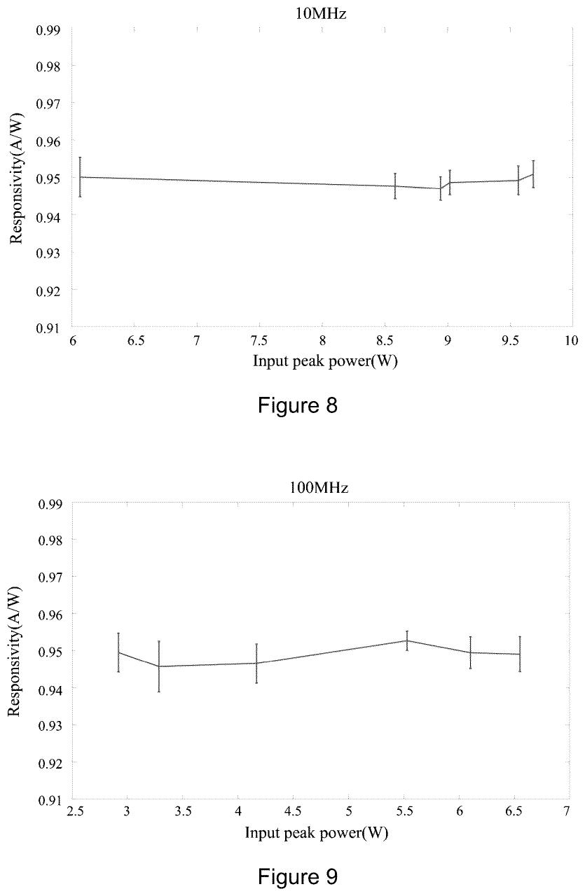

Also, experiments were conducted based on a series of pulsed laser inputs with strong peak power, to verify the effectiveness of the optical power limiter according to an example embodiment in these cases. To this end, two stages of EDFA were used to amplify the pulsed laser signal generated from a 1550 nm semiconductor laser, and the pulse widths (50-500ps) and the repetition rate (1 MHz~100 MHz) of the laser pulse were varied to generate various laser pulse configurations, with peak power ranging from 2.9 W to 14.7 W. In those experiments, no significant changes in photodiode responsivity were observed. The detailed responsivity measurement results with different input peak power in this experiment are shown in FIGS. 7 to 9, illustrating substantially stable responsivity.

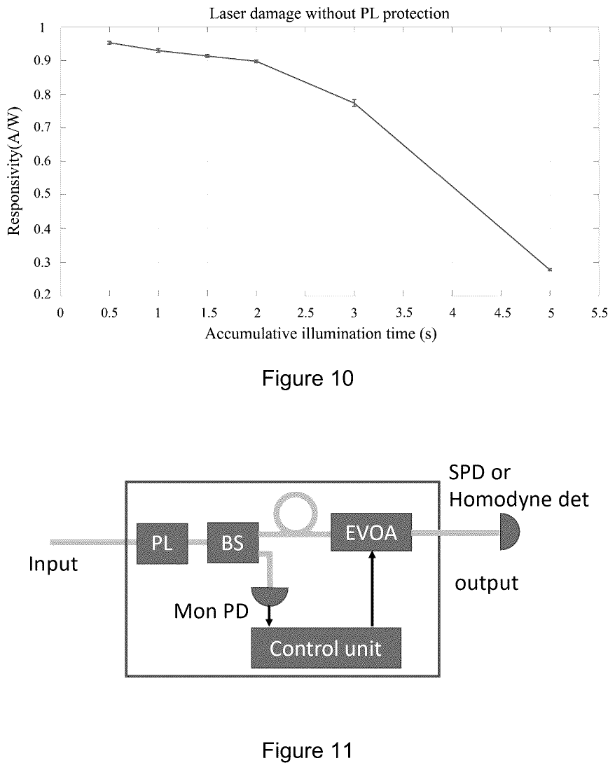

For pulsed laser input, the experiment was also conducted with the optical power limiter removed from the setup. By increasing the accumulative illumination time, and the input pulse fixed at 14.7 W peak power with a 1 MHz repetition rate, it was observed that the responsivity of the photodiode starts decreasing sharply after 2s illumination. The details of the experimental results are shown in FIG. 10.

The optical power limiter according to example embodiments can be a powerful solution for laser damage attack in quantum cryptography, and one can also expect more useful tools and methods can be built based on it. For example, since the calibrated parameter specs of a photodiode is reliable and could not be modified by an eavesdropper when using an optical power limiter according to an example embodiment, one can faithfully monitor the input optical power and perform feedback control to achieve 1) ultra-low power limiting threshold, 2) instantaneous optical power limiting. The schematic of the setup according to an example embodiment is shown in FIG. 11.

Specifically, the input optical signal 1100 will go through a power limiter (PL) 1102 first, and is then split by a beam splitter (BS) 1104. Part of the energy will be sent to a monitoring photodiode (Mon PD) 1106, the rest will be delayed and attenuated (Electronic Variable Optical Attenuators, EVOA) 1108 before being output to a single photon detector (SPD) or Homodyne detector 1110. Since the optical components (monitoring photodiode 1106, beam splitter 1104) are protected by the optical power limiter 1102 and their calibrated parameters are hence reliable, one can monitor the (averaged or instantaneous) input power of the optical signal, and actively control the EVOA 1108 to achieve a desirable output power.

Embodiments of the present invention can have one or more of the following features and associated benefits/advantages:

| Feature | Benefit/Advantage |
|---|---|
| Miniature size | The optical power limiter according to an |
| | example embodiment is able to achieve |
| | optical power limiting with a beam size of |
| | around micro-meter, enabling a small |
| | footprint and a high integration level for |
| | applications. |
| Minimal insertion | The optical power limiter according to an |
| loss | example embodiment optimizes the optical |
| | mode coupling in the low input power case. |
| | So the insertion loss in low input power |
| | scenarios are minimal. |
| Adjustable power | The optical power limiter according to an |
| limiting threshold | example embodiment provides configurable |
| | system parameters to adjust the power |
| | limiting threshold. |
| Minimal distortion | The power limiter according to an example |
| on the signal | embodiment adds only attenuation on the |
| | input optical signal, and introduce minimal |
| | impact (if not, negligible impact) on the |
| | intensity, phase, or polarization degrees of |
| | freedom of the input optical signal. |
| Cost-effectiveness | Composing of only off-the-shelf optical |
| | components and having a simple structure, |
| | the optical power limiter according to an |
| | example embodiment possesses the |
| | advantage of compact size, simple |
| | assembling, and cost-effective, etc. |

The optical power limiter according to example embodiments can be used, for example, in the following applications: protecting optical components in optical communication and sensing systems, limiting eavesdropper's information in quantum cryptography applications, etc.

In one embodiment, an optical power limiter is provided comprising a first optical mode altering element configured to receive an input optical signal from a first waveguide; and an active medium coupled to the first optical mode altering element at a first end of the active medium such that a mode altered optical signal based on the input optical signal can enter the active medium, wherein a second end of the active medium is configured to couple the mode altered optical signal into a second waveguide as an optical output signal; wherein the active medium has a thermo-optic coefficient such that the mode altered optical signal entering the active medium experiences a refractive index gradient in the active medium as a result of absorption; and wherein the power of the optical output signal coupled into the second waveguide is limited to a maximum power value based on mode overlap of the mode altered optical signal and the second waveguide.

The maximum power value may be dependent on an optical path length between the first and second ends of the active medium.

The active medium may have a negative thermo-optic coefficient for diverging the light beam as a result of the refractive index gradient. As a result of the refractive index gradient, the active medium may introduce increased mode mismatch between the mode altered optical signal and the second waveguide with increased divergence of the mode altered optical signal.

The first optical mode altering element may comprise a core expansion in an optical fiber as the first waveguide, a taper structure, or large core waveguide mode converter in a photonic integrated circuit as the waveguide. The optical power limiter may comprise a second optical mode altering element coupled between the second end of the active medium and the second waveguide for optimizing mode overlap between the mode altered optical signal and the second waveguide up to the maximum power value.

The first optical mode altering element may be configured for focusing the mode altered optical signal in the active medium. The first optical mode altering element may comprise one or more of a group consisting of micro lenses, Gradient-Index (GRIN) lenses, collimators, and the waveguide versions of micro lenses, Gradient-Index (GRIN) lenses, collimators.

The optical power limiter may comprise a second optical mode altering element coupled between the second end of the active medium and the second waveguide for optimizing mode overlap between the mode altered optical signal and the second waveguide up to the maximum power value. The second optical mode altering element may comprise one or more of a group consisting of micro lenses, Gradient-Index (GRIN) lenses, collimators, and the waveguide versions of micro lenses, Gradient-Index (GRIN) lenses, collimators.

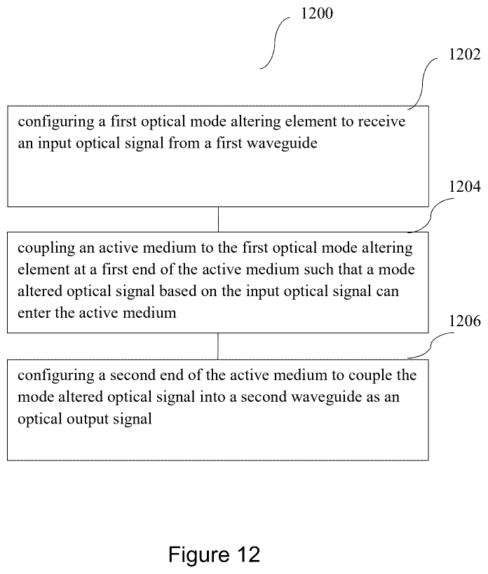

FIG. 12 shows a flowchart 1200 illustrating a method of fabricating an optical power limiter, according to an example embodiment. At step 1202, a first optical mode altering element is configured to receive an input optical signal from a first waveguide. At step 1204, an active medium is coupled to the first optical mode altering element at a first end of the active medium such that a mode altered optical signal based on the input optical signal can enter the active medium. At step 1206, a second end of the active medium is configured to couple the mode altered optical signal into a second waveguide as an optical output signal, wherein the active medium has a thermo-optic coefficient such that the mode altered optical signal entering the active medium experiences a refractive index gradient in the active medium as a result of absorption; and wherein a power of the optical output signal coupled into the second waveguide is limited to a maximum power value based on mode overlap of the mode altered optical signal and the second waveguide.

The maximum power value may be dependent on an optical path length between the first and second ends of the active medium.

The active medium may have a negative thermo-optic coefficient for diverging the light beam as a result of the refractive index gradient. As a result of the refractive index gradient, the active medium may introduce increased mode mismatch between the mode altered optical signal and the second waveguide with increased divergence of the mode altered optical signal.

The first optical mode altering element may comprise a core expansion in an optical fiber as the first waveguide, a taper structure, or large core waveguide mode converter in a photonic integrated circuit as the waveguide. The method may comprise coupling a second optical mode altering element between the second end of the active medium and the second waveguide for optimizing mode overlap between the mode altered optical signal and the second waveguide up to the maximum power value.

The method may comprise configuring the first optical mode altering element for focusing the mode altered optical signal in the active medium. The first optical mode altering element may comprise one or more of a group consisting of micro lenses, Gradient-Index (GRIN) lenses, collimators, and the waveguide versions of micro lenses, Gradient-Index (GRIN) lenses, collimators. The method may comprise coupling a second optical mode altering element between the second end of the active medium and the second waveguide for optimizing mode overlap between the mode altered optical signal and the second waveguide up to the maximum power value. The second optical mode altering element may comprise one or more of a group consisting of micro lenses, Gradient-Index (GRIN) lenses, collimators, and the waveguide versions of micro lenses, Gradient-Index (GRIN) lenses, collimators.

In one embodiment, an optical device or system comprising the power limiter of the above embodiments is provided.

In one embodiment, a method of limiting optical power using the power limiter of the above embodiments is provided.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. An optical power limiter comprising:
a first optical mode altering element configured to receive an input optical signal from a first waveguide; and
an active medium coupled to the first optical mode altering element at a first end of the active medium such that a mode altered optical signal based on the input optical signal can enter the active medium, wherein a second end of the active medium is configured to couple the mode altered optical signal into a second waveguide as an optical output signal;
wherein the active medium has a thermo-optic coefficient such that the mode altered optical signal entering the active medium experiences a refractive index gradient in the active medium as a result of absorption; and
wherein the power of the optical output signal coupled into the second waveguide is limited to a maximum power value based on mode overlap of the mode altered optical signal and the second waveguide.

2. The optical power limiter of claim 1, wherein the maximum power value is be dependent on an optical path length between the first and second ends of the active medium.

3. The optical power limiter of claim 1, wherein the active medium has a negative thermo-optic coefficient for diverging the light beam as a result of the refractive index gradient.

4. The optical power limiter of claim 3, wherein, as a result of the refractive index gradient, the active medium introduces increased mode mismatch between the mode altered optical signal and the second waveguide with increased divergence of the mode altered optical signal.

5. The optical power limiter of claim 1, wherein the first optical mode altering element comprises a core expansion in an optical fiber as the first waveguide, a taper structure, or large core waveguide mode converter in a photonic integrated circuit as the first waveguide, and optionally comprising a second optical mode altering element coupled between the second end of the active medium and the second waveguide for optimizing mode overlap between the mode altered optical signal and the second waveguide up to the maximum power value.

6. (canceled)

7. The optical power limiter of claim 1, wherein the first optical mode altering element is configured for focusing the mode altered optical signal in the active medium.

8. The optical power limiter of claim 7, wherein the first optical mode altering element comprises one or more of a group consisting of micro lenses, Gradient-Index (GRIN) lenses, collimators, and the waveguide versions of micro lenses, Gradient-Index (GRIN) lenses, collimators.

9. The optical power limiter of claim 7, comprising a second optical mode altering element coupled between the second end of the active medium and the second waveguide for optimizing mode overlap between the mode altered optical signal and the second waveguide up to the maximum power value.

10. The optical power limiter of claim 9, wherein the second optical mode altering element comprises one or more of a group consisting of micro lenses, Gradient-Index (GRIN) lenses, collimators, and the waveguide versions of micro lenses, Gradient-Index (GRIN) lenses, collimators.

11. A method of fabricating an optical power limiter comprising:
configuring a first optical mode altering element to receive an input optical signal from a first waveguide;
coupling an active medium to the first optical mode altering element at a first end of the active medium such that a mode altered optical signal based on the input optical signal can enter the active medium; and
configuring a second end of the active medium to couple the mode altered optical signal into a second waveguide as an optical output signal;
wherein the active medium has a thermo-optic coefficient such that the mode altered optical signal entering the active medium experiences a refractive index gradient in the active medium as a result of absorption; and
wherein a power of the optical output signal coupled into the second waveguide is limited to a maximum power value based on mode overlap of the mode altered optical signal and the second waveguide.

12. The method of claim 11, wherein the maximum power value is dependent on an optical path length between the first and second ends of the active medium.

13. The method of claim 11, wherein the active medium has a negative thermo-optic coefficient for diverging the light beam as a result of the refractive index gradient.

14. The method of claim 13, wherein, as a result of the refractive index gradient, the active medium introduces increased mode mismatch between the mode altered optical signal and the second waveguide with increased divergence of the mode altered optical signal.

15. The method of claim 11, wherein the first optical mode altering element comprises a core expansion in an optical fiber as the first waveguide, a taper structure, or large core waveguide mode converter in a photonic integrated circuit as the waveguide, and optionally wherein, as a result of the refractive index gradient, the active medium introduces increased mode mismatch between the mode altered optical signal and the second waveguide with increased divergence of the mode altered optical signal.

16. (canceled)

17. The method of claim 11, wherein the method comprises configuring the first optical mode altering element for focusing the mode altered optical signal in the active medium.

18. The method of claim 17, wherein the first optical mode altering element comprises one or more of a group consisting of micro lenses, Gradient-Index (GRIN) lenses, collimators, and the waveguide versions of micro lenses, Gradient-Index (GRIN) lenses, collimators.

19. The method of claim 17, comprising a second optical mode altering element coupled between the second end of the active medium and the second waveguide for optimizing mode overlap between the mode altered optical signal and the second waveguide up to the maximum power value.

20. The method of claim 19, wherein the second optical mode altering element comprises one or more of a group consisting of micro lenses, Gradient-Index (GRIN) lenses, collimators, and the waveguide versions of micro lenses, Gradient-Index (GRIN) lenses, collimators.

21. An optical device or system comprising the optical power limiter of claim 1.

22. A method of limiting optical power using the optical power limiter of claim 1.
